(19) United States
(12) Patent Application Publication
(10) Pub. No.: US 2010/0169403 A1
(43) Pub. Date: Jul. 1, 2010

(54) SYSTEM FOR MATRIX PARTITIONING IN LARGE-SCALE SPARSE MATRIX LINEAR SOLVERS

(75) Inventors: Matthew P. DeLaquil, Rockwall, TX (US); Deepak Prasanna, Rockwall, TX (US); Scott M. Burkart, Royse City, TX (US); Joshua D. Anderson, Garland, TX (US); Aya Nagao Bennett, Rockwall, TX (US)

Correspondence Address: HOVEY WILLIAMS LLP, 10801 Mastin Blvd., Suite 1000, Overland Park, KS, 66210, US

(73) Assignee: L3 COMMUNICATIONS INTEGRATED SYSTEMS, L.P., Greenville, TX (US)

(21) Appl. No.: 12/347,407

(22) Filed: Dec. 31, 2008

(51) Int. Cl. G06F 17/11; G06F 17/16

(52) U.S. Cl. 708/446

(57) ABSTRACT

A system for solving large-scale matrix equations comprises a plurality of field programmable gate arrays (FPGAs), a plurality of memory elements, a plurality of memory element controllers, and a plurality of processing elements. The FPGAs may include a plurality of configurable logic elements and a plurality of configurable storage elements. The memory elements may be accessible by the FPGAs and may store a matrix and a first vector. The memory element controllers may be formed from configurable logic elements and configurable storage elements and may supply at least a portion of a row of the matrix and at least a portion of the first vector. Each processing element may receive at least the row of the matrix and the first vector and solve an iteration for one element of the first vector.

### BACKGROUND OF THE INVENTION

1. Field of the Invention

Embodiments of the present invention relate to high-performance computing. More particularly, embodiments of the invention relate to solving a large-scale matrix equation using a system that includes reconfigurable computing devices.

2. Description of the Related Art

Many high-performance computing applications in science and engineering, involving fields such as computational fluid dynamics, electromagnetics, geophysical exploration, economics, linear programming, astronomy, chemistry, and structural analysis, require the solution to large matrix equations. The matrix equation may take the form Ax=b, where A is a known n×n matrix, b is a known vector of size n, and x is an unknown vector if size n. Some approaches to finding the solution vector, x, involve the usage of reconfigurable computing devices, such as field programmable gate arrays (FPGAs). In some instances requiring extremely high performance, the solution vector may include millions of elements. In such cases, the reconfigurable computing device may not be able to store the solution vector in its own internal memory. Thus, the solution vector may be stored in a memory unit external to the reconfigurable computing device. As a result, the performance of the reconfigurable computing device may be reduced due to the latency involved in accessing the external memory unit to retrieve and update the solution vector.

In other instances, the nature of the problem to be solved, the characteristics of the system that is modeled, or similar circumstances may produce a matrix, A, that is sparsely populated. In other words, a significant portion of the elements of the matrix may have a value of zero. Traditional matrix linear solvers may not recognize this fact and take advantage of it. As a result, performance may be sacrificed by unnecessarily retrieving data and performing calculations.

### SUMMARY OF THE INVENTION

Embodiments of the present invention solve the above-mentioned problems and provide a distinct advance in the art of high performance computing. More particularly, embodiments of the invention provide a system that includes reconfigurable computing devices that find the solution to a large-scale matrix equation wherein the solution vector may be extremely large or the matrix may include sparse data.

Various embodiments of the system for solving a large-scale matrix equation involving a matrix, a first vector, and a second vector comprise a plurality of field programmable gate arrays (FPGAs), a matrix memory element, a plurality of matrix memory element controllers, and a plurality of processing elements.

Each FPGA includes a plurality of configurable logic elements and a plurality of configurable storage elements. The matrix memory element may be accessible by the FPGAs and may be configured to store the matrix. The matrix memory element controllers may be formed from the configurable logic elements and the configurable memory elements and may be configured to access the matrix memory element and to supply a plurality of portions of a row of the matrix to the processing elements.

Each processing element generally solves an iteration of an element of the first vector. Each processing element may store a portion of the first vector and at least one element of the second vector. Each processing element includes a matrix-vector product summation unit that calculates the matrix-vector product sum by receiving all of the portions of the vector from other processing elements and all of the portions of a row from the memory element controller. A linear solver update unit receives the matrix-vector product sum along with an element of the second vector, an inverse of the row diagonal of the matrix, and the element of the first vector that was calculated in a previous iteration. From these values, the linear solver update unit calculates the element of the first vector for the current iteration. The other processing elements calculate the values of the other elements in the first vector. In the next iteration, the current values of the first vector are used to calculate new values of the first vector. The iterations continue until a stopping criteria is met and the solution of the first vector is established.

Another embodiment of the system solves a large-scale matrix equation involving a sparse matrix, a first vector, and a second vector. The system may be substantially similar to the system described above but may further include a vector memory element and a vector memory element controller. Other differences may be described as follows.

The matrix memory element controller may be configured to access the matrix memory element and to supply non-zero data of a row of the matrix. The vector memory element may be accessible by the FPGAs and may be configured to store the first vector. The vector memory element controllers may be formed from the configurable logic elements and the configurable memory elements and may be configured to access the vector memory element and to supply matching elements of the first vector that correspond to the non-zero data of the row of the matrix.

The matrix-vector product summation unit may receive the non-zero data of the row of the matrix and the matching elements of the first vector to calculate the matrix-vector product sum. The linear solver update unit calculates the element of the first vector for the current iteration, as described above. Likewise, the iterations continue until a final solution for the first vector is found.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a system for matrix partitioning with a large-scale matrix linear solver constructed in accordance with various embodiments of the current invention;

FIG. 2 is a schematic diagram of a field programmable gate array;

FIG. 3 is a schematic diagram of a first embodiment of a processing element;

FIG. 4 is a schematic diagram of a second embodiment of the system; and

FIG. 5 is a schematic diagram of a second embodiment of the processing element.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

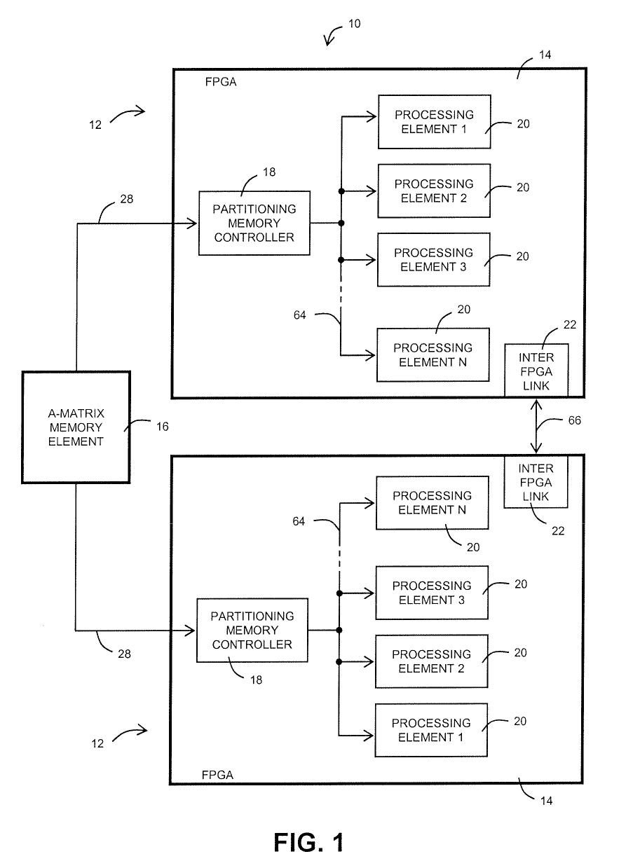

A system 10 for matrix partitioning in large-scale sparse matrix iterative linear solvers, as constructed in accordance with various embodiments of the current invention, is shown in FIG. 1. The system 10 may broadly comprise a plurality of reconfigurable computing devices 12, such as field programmable gate arrays (FPGAs) 14, a matrix memory element 16, a plurality of partitioning memory controllers 18, a plurality of processing elements 20, and a plurality of inter FPGA links 22. The system 10 may generally find a solution to a matrix equation that includes a solution vector when the solution vector is too large to be stored in a single reconfigurable computing device 12. The system 10 may also find a solution to the matrix equation when the matrix is sparsely populated.

The matrix equation may have the form Ax=b, where A is a known n×n matrix (referred to as the “A-matrix”), b is a known vector of size n (referred to as the “b-vector”), and x is an unknown vector of size n (referred to as the “x-vector” or alternatively the “solution vector”). The matrix and the two vectors may all have a total of n rows. For a large scale matrix equation, n may be in the millions. The matrix equation may be expanded as shown in EQ. 1:

$$[ \begin{matrix}{A}_{11} & {A}_{12} & ⋯ & {A}_{1 n} \\ {A}_{21} & {A}_{22} & ⋯ & {A}_{2 n} \\ ⋮ & ⋮ & ⋰ & ⋮ \\ {A}_{n 1} & {A}_{n 2} & ⋯ & {A}_{nn}\end{matrix} ] [ \begin{matrix}{x}_{1} \\ {x}_{2} \\ ⋮ \\ {x}_{n}\end{matrix} ] = [ \begin{matrix}{b}_{1} \\ {b}_{2} \\ ⋮ \\ {b}_{n}\end{matrix} ] \qquad EQ . 1$$

One approach to solving the matrix equation for x involves approximating an initial solution for x and then iteratively solving the matrix equation to find successive solutions for x. The approach may include solving EQ. 2 for one element of the x-vector for one iteration, as shown:

xᵣ_{_{—}}ₙₑₓₜ=xᵣ+Δxᵣ EQ. 2

wherein xᵣ_{_{—}}ₙₑₓₜ is the value of the element of the x-vector in row r that is being calculated in the current iteration, xᵣ is the value of the element of the x-vector in row r that was calculated in the last iteration, and Δxᵣ is the incremental change of xᵣ, which is given by EQ. 3:

$$Δ {x}_{r} = \frac{1}{{D}_{r}} ( {b}_{r} - \sum {A}_{r} \cdot x ) \qquad EQ . 3$$

such that Dᵣ is the diagonal of the row r from A-matrix, bᵣ is the element of the known b-vector in row r, Aᵣ is the all the values in row r of A-matrix, and x is all the values of the x-vector that were calculated in the last iteration of the solution.

In applying the iterative process, the term xᵣ_{_{—}}ₙₑₓₜ is substituted for xᵣ in the next iteration. Furthermore, xᵣ for all the other rows of the x-vector may be calculated during a single iteration as well, possibly simultaneously or nearly simultaneously. At the end of the iteration, the x-vector is updated by receiving all the newly calculated values of xᵣ. Thus, for each iteration, each individual element of the x-vector is calculated using all the values of the x-vector that were calculated in the last iteration. The iterations continue until some condition for stopping is met, such as Δxᵣ is very small, and the solution for the x-vector is determined.

The iterative equations of EQ. 2 and EQ. 3 may include a linear solver update component and a matrix vector product summation component. The term ΣAᵣ·x forms the matrix vector product summation component. The rest of EQ. 3 and the addition portion of EQ. 2 forms the linear solver update component as the incremental change, Δxᵣ, is added to xᵣ to update its value.

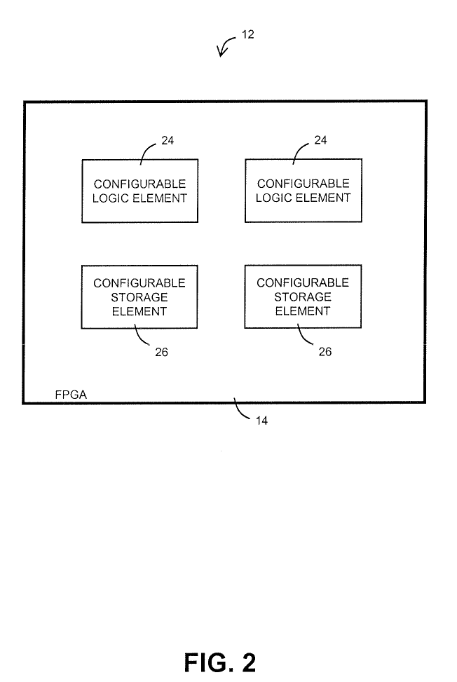

The FPGA 14 generally provides the resources to implement the partitioning memory controllers 18, the processing elements 20, and the inter FPGA links 22. The FPGA 14, as seen in FIG. 2, may include configurable logic elements 24 or blocks, such as standard gate array components that include combinational logic gates (e.g., AND, OR, and NOT) and latches or registers, programmable switch and interconnect networks, configurable storage elements 26 such as random-access memory (RAM) components, and input/output (I/O) pads. The FPGA 14 may also include specialized functional blocks such as arithmetic/logic units (ALUs) that include high-performance adders and multipliers, or communications blocks for standardized protocols. An example of the FPGA 14 is the Xilinx Virtex™ series, particularly the Virtex™2Pro FPGA, from Xilinx, Inc. of San Jose, Calif.

The FPGA 14 may be programmed in a generally traditional manner using electronic programming hardware that couples to standard computing equipment, such as a workstation, a desktop computer, or a laptop computer. The functional description or behavior of the circuitry may be programmed by writing code using a hardware description language (HDL), such as very high-speed integrated circuit hardware description language (VHDL) or Verilog, which is then synthesized and/or compiled to program the FPGA 14. Alternatively, a schematic of the circuit may be drawn using a computer-aided drafting or design (CAD) program, which is then converted into FPGA 14 programmable code using electronic design automation (EDA) software tools, such as a schematic-capture program. The FPGA 14 may be physically programmed or configured using FPGA programming equipment, as is known in the art.

The matrix memory element 16 generally stores all the values of the A-matrix. The matrix memory element 16 may receive the values of the A-matrix from an external source, and may be updated either in full or in part each time a solution for the x-vector is found. The matrix memory element 16 may also receive requests and/or control signals from the partitioning memory controllers 18 to send A-matrix data to each partitioning memory controller 18 to be distributed to the processing elements 20. The matrix memory element 16 may include a matrix memory data output 28, through which A-matrix data is transmitted. The matrix memory data output 28 may include serial lines, multi-bit parallel busses, or combinations thereof, and may follow a standardized protocol, such as PCI Express, or the like.

The matrix memory element 16 may include random-access memory (RAM) elements, multi-port RAM elements, read-only memory (ROM) elements, programmable ROM (PROM) elements, buffers, registers, flip-flops, floppy disks, hard-disk drives, optical disks, or combinations thereof.

In various embodiments, the number of elements in the x-vector may be too large for the x-vector to be stored in a single FPGA 14. In such embodiments, the x-vector may be divided into a plurality of subsets, xₛ, such that the x-vector is the concatenation of xₛᵢ, where i is an index with a range from 1 to m, m being the total number of subsets. The x-vector may be divided into equal-sized subsets or the size of each subset may vary. The x-vector may also be divided such that at least one subset of the x-vector, xₛ, is stored on an FPGA 14, while in certain embodiments, more than one subset is stored on an FPGA 14.

The processing element 20 generally calculates one element of the x-vector, xᵣ_{_{—}}ₙₑₓₜ from EQ. 2. Dividing the x-vector into subsets, xₛ, generally has an effect on the calculation of xᵣ_{_{—}}ₙₑₓₜ. From EQ. 3, it can be seen that xᵣ_{_{—}}ₙₑₓₜ depends on the matrix-vector product summation, ΣAᵣ·x, which usually requires a whole row, r, of the A-matrix and the entire x-vector. With the x-vector divided into subsets, each row, r, of the A-matrix is divided into matching subsets, Aᵣₛ, as well, such that the number of elements in xₛ is equivalent to the number of elements in Aᵣₛ. As a result, the matrix-vector product summation may be calculated in stages, with each processing element 20 successively calculating a subset of the matrix-vector product summation, ΣAᵣₛ·xₛ, until all subsets have been accumulated to find the total matrix-vector product summation, ΣAᵣ·x, for a given row, r. In alternative embodiments, a separate processing element 20 may be responsible for calculating the matrix-vector product summation for all rows.

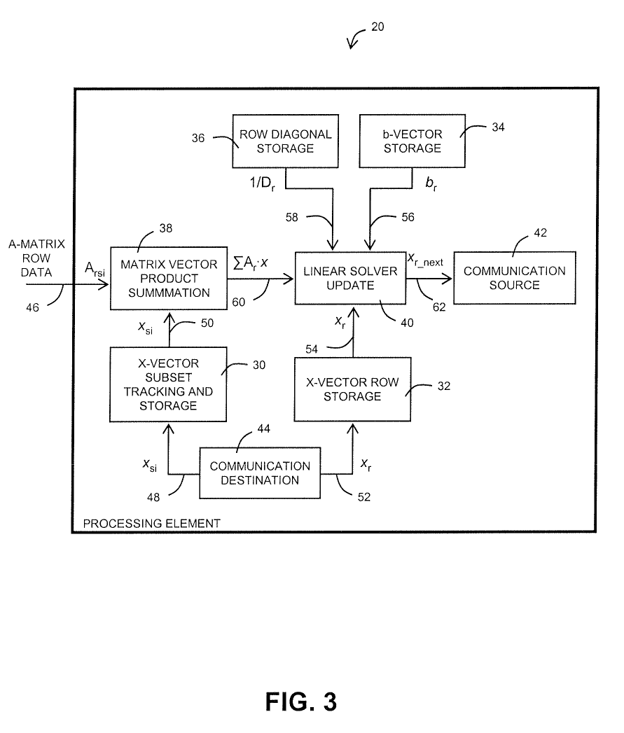

The processing element 20, as shown in FIG. 3, may include an x-vector subset tracking and storage element 30, an x-vector row storage element 32, a b-vector storage element 34, a row diagonal storage element 36, a matrix-vector product summation unit 38, a linear solver update unit 40, a communication source element 42, and a communication destination element 44. The processing element 20 may also include a matrix row data input 46, which generally receives data from the partitioning memory controller 18.

The x-vector subset tracking and storage element 30 generally tracks and stores the subsets of the x-vector, xₛᵢ. The x-vector subset tracking and storage element 30 may receive an x-vector subset data input 48 from the communication destination element 44 that includes the x-vector subset data as well as an index tag to identify which subset is being received. The x-vector subset tracking and storage element 30 may receive all the subsets of the x-vector during one iteration. The x-vector subset tracking and storage element 30 may also transmit an x-vector subset data output 50 as requested by the matrix-vector product summation unit 38 or at regular intervals.

The x-vector subset tracking and storage element 30 may be formed from combinational logic gates, e.g., AND, OR, and NOT, control logic blocks such as finite state machines (FSMs), as well as configurable storage elements 26, such as first-in first-out registers (FIFOs), single-port or multi-port RAM elements, memory cells, registers, latches, flip-flops, combinations thereof, and the like. The x-vector subset tracking and storage element 30 may also include built-in components of the FPGA 14, and may further be implemented through one or more code segments of an HDL.

The x-vector row storage element 32 generally stores the element of the x-vector for row r, xᵣ. The x-vector row storage element 32 may receive an x-vector row data input 52 from the communication destination element 44 and may transmit an x-vector row data output 54 to the linear solver update unit 40. The x-vector row storage element 32 may receive the x-vector row data input 52 at the end of each iteration. The x-vector row storage element 32 may supply the x-vector row data output 54 as necessary.

The x-vector row storage element 32 may be formed from configurable storage elements 26, such as FIFOs, single-port or multi-port RAM elements, memory cells, registers, latches, flip-flops, combinations thereof, and the like. The x-vector row storage element 32 may also include built-in components of the FPGA 14, and may further be implemented through one or more code segments of an HDL.

The b-vector storage element 34 generally stores the element of the b-vector for row r, bᵣ. The b-vector storage element 34 may transmit a b-vector row data output 56 to the linear solver update unit 40, as necessary. The b-vector storage element 34 may receive the b-vector row data from an external source or other components of the system once a solution for the x-vector is found.

The b-vector storage element 34 may be formed from configurable storage elements 26, such as FIFOs, single-port or multi-port RAM elements, memory cells, registers, latches, flip-flops, combinations thereof, and the like. The b-vector storage element 34 may also include built-in components of the FPGA 14, and may further be implemented through one or more code segments of an HDL.

The row diagonal storage element 36 generally stores the data for a given row of the A-matrix. The row diagonal storage element 36 may receive A-matrix row data for the row, r, from the matrix memory element 16. From the row data, the row diagonal storage element 36 may calculate the row diagonal, Dᵣ, and the inverse of the row diagonal, 1/Dᵣ. Thus, the row diagonal storage element 36 may supply a row diagonal inverse output 58 to the linear solver update unit 40 as necessary.

The row diagonal storage element 36 may be formed from configurable logic elements 24 such as combinational logic gates, as well as adders, multipliers, shift registers, combinations thereof, and the like. The row diagonal storage element 36 may also be formed from configurable storage elements 26, such as FIFOs, single-port or multi-port RAM elements, memory cells, registers, latches, flip-flops, combinations thereof, and the like. The row diagonal storage element 36 may also include built-in components of the FPGA 14, and may further be implemented through one or more code segments of an HDL.

The matrix-vector product summation unit 38 generally calculates the matrix-vector product summation, ΣAᵣ·x, for a given row, r, of the A-matrix. The matrix-vector product summation unit 38 may receive the subset of x-vector data, xₛᵢ, through the x-vector subset data output 50 as well as the corresponding subset of the row data for the A-matrix, Aᵣₛᵢ, from the matrix row data input 46. With these two sets of data, the matrix-vector product summation unit 38 may calculate a subset of the matrix-vector product sum, ΣAᵣₛᵢ·Xₛᵢ. The matrix-vector product summation unit 38 may then receive another subset of the x-vector data, xₛᵢ, and another subset of the A-matrix data, Aᵣₛᵢ, to calculate another subset of the sum. The earlier calculated subset of the sum may be temporarily stored to be finally added later or may be successively added to the ongoing sum. Once all the subsets of the matrix-vector product summation have been added, the matrix-vector product summation unit 38 may transmit the total sum, ΣAᵣ·x, as a matrix-vector product summation output 60 to the linear solver update unit 40.

The matrix-vector product summation unit 38 may be formed from configurable logic elements 24 such as combinational logic gates, as well as adders, multipliers, shift registers, accumulators, multiply-accumulate units (MACs), combinations thereof, and the like. The matrix-vector product summation unit 38 may also be formed from configurable storage elements 26, such as FIFOs, single-port or multi-port RAM elements, memory cells, registers, latches, flip-flops, combinations thereof, and the like. The matrix-vector product summation unit 38 may also include built-in components of the FPGA 14, and may further be implemented through one or more code segments of an HDL.

The linear solver update unit 40 generally calculates xᵣ_{_{—}}ₙₑₓₜ. The linear solver update unit 40 may receive the b-vector row data output 56, the row diagonal inverse output 58, the x-vector row data output 54, and the matrix-vector product summation output 60. From these signals, the linear solver update unit may calculate xᵣ_{_{—}}ₙₑₓₜ as given by EQ. 2 and EQ. 3, and transmit an x-vector solution output 62.

The linear solver update unit 40 may be formed from configurable logic elements 24 such as combinational logic gates, as well as adders, multipliers, shift registers, accumulators, multiply-accumulate units (MACs), combinations thereof, and the like. The linear solver update unit 40 may also be formed from configurable storage elements 26, such as FIFOs, single-port or multi-port RAM elements, memory cells, registers, latches, flip-flops, combinations thereof, and the like. The linear solver update unit 40 may also include built-in components of the FPGA 14, and may further be implemented through one or more code segments of an HDL.

The communication source element 42 generally broadcasts data from one processing element 20 to all the other processing elements 20. The communication source element 42 may transmit the x-vector solution output 62. The communication source element 42 may also transmit the subset of the x-vector data, xₛ.

The communication destination element 44 generally receives the data that is broadcast from all the other processing elements 20. The communication destination element 44 may receive xᵣ_{_{—}}ₙₑₓₜ from all the other processing elements 20 from which row data of the x-vector, x-vector row data input 52, may be derived. The communication destination element 44 may also receive the subsets of the x-vector data, xₛᵢ, from the other processing elements 20, from which the x-vector subset data input 48 is derived.

The communication source element 42 and the communication destination element 44 may be formed from configurable logic elements 24 such as combinational logic gates, multiplexers, demultiplexers, crossbar or crossover or crosspoint switches, combinations thereof, and the like. The communication source element 42 and the communication destination element 44 may also be formed from configurable storage elements 26, such as FIFOs, single-port or multi-port RAM elements, memory cells, registers, latches, flip-flops, combinations thereof, and the like. The communication source element 42 and the communication destination element 44 may also include built-in components of the FPGA 14, and may further be implemented through one or more code segments of an HDL. In addition, the communication source element 42 and the communication destination element 44 may include an architecture such as the one described in “SWITCH-BASED PARALLEL DISTRIBUTED CACHE ARCHITECTURE FOR MEMORY ACCESS ON RECONFIGURABLE COMPUTING PLATFORMS”, U.S. patent application Ser. No. 11/969,003, filed Jan. 3, 2008, which is herein incorporated by reference in its entirety.

Referring to FIG. 1, the partitioning memory controller 18 generally partitions the data from each row of the A-matrix to be distributed to the processing elements 20. The partitions, or subsets, of the rows of the A-matrix, Aᵣₛ, may correspond to the subsets of the x-vector, xₛ. For example, if the first subset of the x-vector, xₛ₁, includes two elements (in row form), then the first subset of the rows of the A-matrix, Aᵣₛ₁, includes two columns, as seen in EQ. 1. The partitioning memory controller 18 may receive the matrix memory data output 28 and may generate a partitioned memory data output 64 that includes the appropriate row subset of A-matrix data for the particular x-vector subset for each processing element 20. The partitioned memory data output 64 may be received by the matrix row data input 46 of the processing element 20.

The partitioning memory controller 18 may be formed from configurable logic elements 24 such as combinational logic gates, FSMs, combinations thereof, and the like. The partitioning memory controller 18 may also be formed from configurable storage elements 26, such as FIFOs, single-port or multi-port RAM elements, memory cells, registers, latches, flip-flops, combinations thereof, and the like. The partitioning memory controller 18 may also include built-in components of the FPGA 14, and may further be implemented through one or more code segments of an HDL.

The inter FPGA link 22 generally allows communication from the components, such as the processing elements 20, on one FPGA 14 to the components on another FPGA 14. The inter FPGA link 22 may buffer the data and add packet data, serialize the data, or otherwise prepare the data for transmission.

The inter FPGA link 22 may include buffers in the form of flip-flops, latches, registers, SRAM, DRAM, and the like, as well as shift registers or serialize-deserialize (SERDES) components. The inter FPGA link 22 may be a built-in functional FPGA block or may be formed from one or more code segments of an HDL or one or more schematic drawings. The inter FPGA link 22 may also be compatible with or include Gigabit Transceiver (GT) components, as are known in the art. The inter FPGA link 22 may receive data from the communication source element 42 and may transmit data to the communication destination element 44. The inter FPGA link 22 may couple to an inter FPGA bus 66 to communicate with another FPGA 14.

The inter FPGA bus 66 generally carries data from one FPGA 14 to another FPGA 14 and is coupled with the inter FPGA link 22 of each FPGA 14. The inter FPGA bus 66 may be a single-channel serial line, wherein all the data is transmitted in serial fashion, a multi-channel (or multi-bit) parallel link, wherein different bits of the data are transmitted on different channels, or variations thereof, wherein the inter FPGA bus 66 may include multiple lanes of bi-directional data links. The inter FPGA bus 66 may be compatible with GTP components included in the inter FPGA link 22. The inter FPGA link 22 and the inter FPGA bus 66 may also be implemented as disclosed in U.S. Pat. No. 7,444,454, issued Oct. 28, 2008, which is hereby incorporated by reference in its entirety.

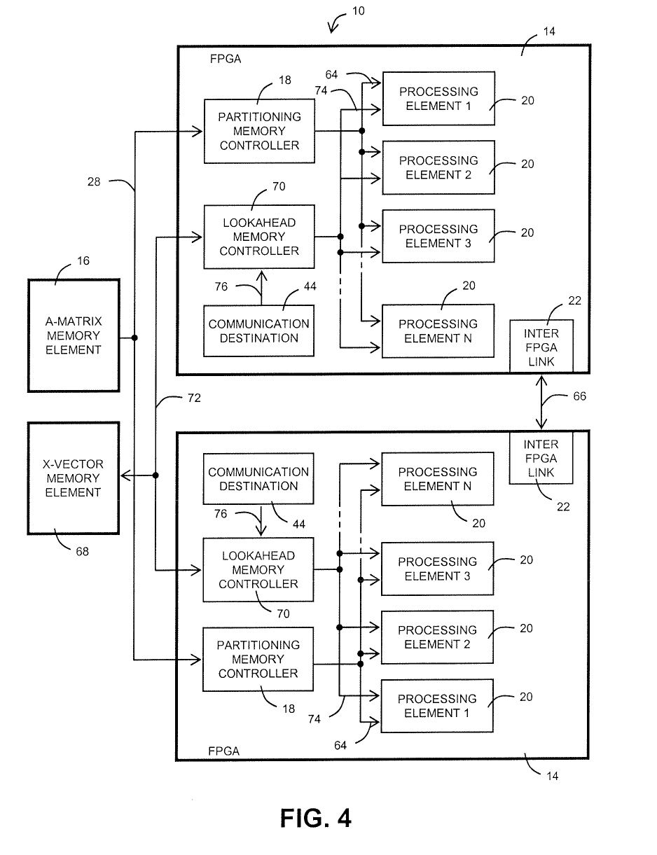

In other embodiments of the system 10, the A-matrix may be a sparse data matrix, in which a significant portion of the elements of the A-matrix may have a value of zero. Thus, the calculation of the matrix-vector product summation, ΣAᵣ·x, may be affected. Since Aᵣ may include only a small percentage of non-zero elements, only the corresponding elements of the x-vector need to be retrieved for the summation calculation. Furthermore, since the index of the non-zero elements of the A-matrix may be different for each row, the corresponding elements of the x-vector required for the summation calculation may differ as well. As a result, in another embodiment, the system 10 may include a vector memory element 68, and a plurality of lookahead memory controllers 70, as shown in FIG. 4.

The vector memory element 68 generally stores all the values of the x-vector. The vector memory element 68 may receive the values of an initial approximation for the x-vector from an external source, and may be updated by the lookahead memory controller 70 after every iteration of the calculation of xᵣ_{_{—}}ₙₑₓₜ is performed. The vector memory element 68 may also receive requests and/or control or timing signals from the lookahead memory controllers 70 to send or receive x-vector data. The vector memory element 68 may include a vector memory data bus 72, through which x-vector data is transmitted and received. The vector memory data bus 72 may include serial lines, multi-bit parallel busses, or combinations thereof, and may follow a standardized protocol, such as PCI Express, or the like.

The vector memory element 68 may include RAM elements, multi-port RAM elements, ROM elements, PROM elements, buffers, registers, flip-flops, floppy disks, hard-disk drives, optical disks, or combinations thereof.

The lookahead memory controller 70 generally retrieves the elements of the x-vector that correspond to the non-zero values for a given row, r, of the A-matrix. For example, if the non-zero elements for a given row, r, of the A-matrix are located in columns 1, 10, and 50, then the lookahead memory controller 70 may retrieve elements 1, 10, and 50 from the vector memory element 68. Thus, a subset of the x-vector may be created for each row, r, of the A-matrix. However, in contrast to the x-vector subsets discussed above, which generally included contiguous portions of the x-vector and were the same for each row, the x-vector subsets of the current embodiments include only those elements corresponding to non-zero elements of the A-matrix and may be different for each row. The lookahead memory controller 70 may then transmit the appropriate subset of the x-vector, xₛ, for row r to the processing element 20 that is calculating xᵣ_{_{—}}ₙₑₓₜ for row r. Accordingly, the lookahead memory controller may receive the vector memory data bus 72 and may transmit an x-vector sparse data output 74.

The lookahead memory controller 70 may be formed from configurable logic elements 24 such as combinational logic gates, control logic blocks such as FSMs, combinations thereof, and the like. The lookahead memory controller 70 may also be formed from configurable storage elements 26, such as FIFOs, single-port or multi-port RAM elements, memory cells, registers, latches, flip-flops, combinations thereof, and the like. The lookahead memory controller 70 may also include built-in components of the FPGA 14, and may further be implemented through one or more code segments of an HDL.

The system 10 may function substantially the same as the system 10 of FIG. 1, described above, with the following exceptions. The communication destination element 44 may be positioned external to the processing elements 20. The communication destination element 44 may receive all the xᵣ_{_{—}}ₙₑₓₜ values from the processing elements 20 and may transmit an x-vector solution input 76 to the lookahead memory controller 70, which may then update the vector memory element 68. The partitioning memory controller 18 may transmit only the non-zero elements of each row, r, of the A-matrix to the processing element 20 that is calculating xᵣ_{_{—}}ₙₑₓₜ for the row, r.

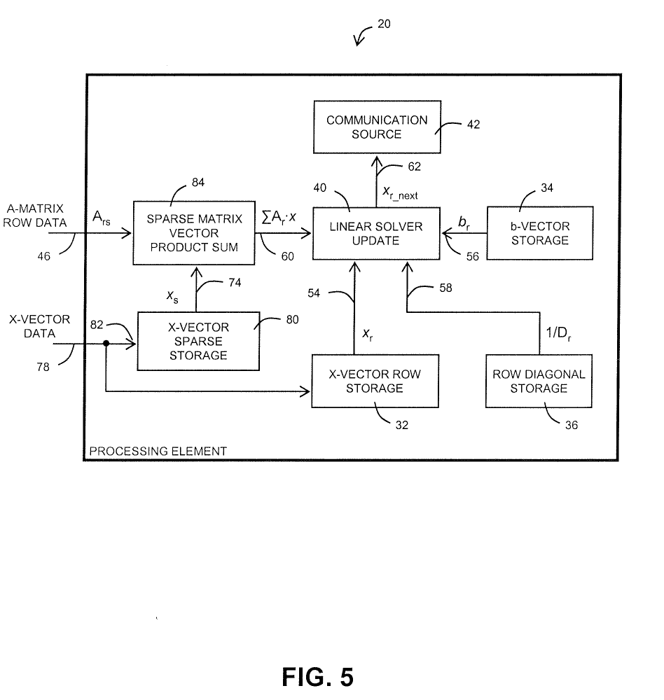

The components of another embodiment of the processing element 20, shown in FIG. 5, may function similarly to those described above with the following exceptions. The communication destination element 44 is located and operates outside of the processing element 20. The processing element 20 may include a vector data input 78 which receives data from the x-vector sparse data output 74. The vector data input 78 may be transmitted to the x-vector row storage element 32. The processing element 20 may also include an x-vector sparse storage element 80 to store the x-vector data that corresponds to the sparse non-zero elements of each row, r, of the A-matrix. The x-vector sparse storage element 80 may receive the x-vector data from the vector data input 78. The x-vector sparse storage element 80 may also transmit an x-vector sparse data input 82, that includes sparse x-vector data, xₛ.

The processing element may further include a sparse matrix-vector product summation unit 84, which may be structurally equivalent to the matrix-vector product summation unit 38 as described above. However, the sparse matrix-vector product summation unit 84 may compute the matrix-vector product summation, ΣAᵣ·x, wherein Aᵣ includes only the non-zero elements of row r, (Aᵣ) and x includes only the corresponding x-vector elements (xₛ).

Embodiments of the system 10 as shown in FIG. 1 may operate as follows. A plurality of processing elements 20 may be established in one or more FPGAs 14. Each processing element 20 may calculate the solution of the x-vector for one element of the x-vector, xᵣ_{_{—}}ₙₑₓₜ, although during different iterations of the solution, the processing element 20 may calculate the solution for different elements of the x-vector. The values of the known A-matrix may be received from an external source and stored in the matrix memory element 16. The values of the known b-vector may be received from an external source and stored in the b-vector storage elements 34 in each processing element 20. An initial approximation to the solution for the x-vector may be received from an external source and stored in the x-vector subset tracking and storage elements 30 and the x-vector row storage elements 32 in each processing element 20.

Each processing element 20 may proceed to calculate each element of the x-vector, xᵣ_{_{—}}ₙₑₓₜ, as given by EQ. 2 and EQ. 3—generally one x-vector element per processing element 20. The calculations may be performed substantially in parallel and possibly asynchronously. The matrix-vector product summation, ΣAᵣ·x, may be calculated in stages by the matrix-vector product summation unit 38, which receives all the subsets of the x-vector data and the corresponding subsets of the A-matrix data for a given row. The linear solver update unit 40 receives the matrix-vector product summation, ΣAᵣ·x, as well as the previous value of the x-vector, xᵣ, the b-vector element, bᵣ, and the inverse diagonal value, 1/Dᵣ, and calculates xᵣ_{_{—}}ₙₑₓₜ as shown in FIG. 3.

Once all the xᵣ_{_{—}}ₙₑₓₜ values are calculated for the x-vector, each processing element 20 broadcasts the xᵣ_{_{—}}ₙₑₓₜ value and an iteration is complete. For the next iteration, each xᵣ value is replaced with the xᵣ_{_{—}}ₙₑₓₜ value from the current iteration. The iterations to find a solution for the x-vector continue until some stopping criterion is met, such as the magnitude of Δxᵣ falls below a certain threshold. The solution for the x-vector is then transmitted to an external destination.

Embodiments of the system 10 as shown in FIG. 4 may operate similarly to the system 10 of FIG. 1, with exceptions as follows. The x-vector initial approximation may be received from an external source and stored in the vector memory element 68. The calculations for an iteration may proceed as discussed above except that the matrix-vector product summation, ΣAᵣ·x, may be calculated from the non-zero elements of the given row of the A-matrix and the corresponding elements of the x-vector. The summation may be performed by the sparse matrix-vector product summation unit 84 and then transferred to the linear solver update unit 40, which calculates xᵣ_{_{—}}ₙₑₓₜ as described above.

Likewise, the iterations to find a solution for the x-vector continue until some stopping criterion is met and the solution for the x-vector is then transmitted to an external destination, as described above.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for solving a matrix equation involving a matrix, a first vector, and a second vector, the system comprising:
a plurality of field programmable gate arrays (FPGAs), each including a plurality of configurable logic elements and a plurality of configurable storage elements;
a memory element accessible by the FPGAs and configured to store the matrix;
a plurality of memory element controllers formed from the configurable logic elements and the configurable memory elements and configured to access the memory element and supply a plurality of portions of a row of the matrix; and
a plurality of processing elements formed from the configurable logic elements and the configurable storage elements, each processing element configured to store a subset of the first vector and at least one element of the second vector, to receive the portions of the row of the matrix, and to solve an iteration for one element of the first vector.

2. The system of claim 1, wherein each processing element further includes a matrix-vector product summation unit configured to receive all the elements of the first vector and all the elements of the row of the matrix and to calculate a matrix-vector product sum.

3. The system of claim 2, wherein each processing element further includes a linear solver update unit configured to receive the matrix-vector product sum and the one element of the first vector from a previous iteration and to solve a current iteration for the one element of the first vector.

4. The system of claim 3, wherein the linear solver update unit further receives the one element of the second vector.

5. The system of claim 3, wherein the linear solver update unit further receives an inverse of a diagonal of the row of the matrix.

6. The system of claim 1, wherein each processing element further includes a communication transmission element configured to transmit the iteration for one element of the first vector to the plurality of processing elements.

7. The system of claim 1, further including a plurality of inter FPGA links, each inter FPGA link included within one FPGA and configured to allow communication from one FPGA to another FPGA.

8. A system for solving a matrix equation involving a matrix, a first vector, and a second vector, the system comprising:
a plurality of field programmable gate arrays (FPGAs), each including a plurality of configurable logic elements and a plurality of configurable storage elements;
a memory element accessible by the FPGAs and configured to store the matrix;
a plurality of memory element controllers formed from the configurable logic elements and the configurable memory elements and configured to access the memory element and supply a plurality of portions of a row of the matrix; and
a plurality of processing elements formed from the configurable logic elements and the configurable storage elements, each processing element further including
a matrix-vector product summation unit configured to receive all the elements of the first vector and all the elements of the row of the matrix and to calculate a matrix-vector product sum, and
a linear solver update unit configured to receive the matrix-vector product sum and the one element of the first vector from a previous iteration and to solve a current iteration for the one element of the first vector.

9. The system of claim 8, wherein the linear solver update unit further receives the one element of the second vector.

10. The system of claim 8, wherein the linear solver update unit further receives an inverse of a diagonal of the row of the matrix.

11. The system of claim 8, wherein each processing element further includes a communication transmission element configured to transmit the iteration for one element of the first vector to the plurality of processing elements.

12. The system of claim 8, further including a plurality of inter FPGA links, each inter FPGA link included within one FPGA and configured to allow communication from one FPGA to another FPGA.

13. A system for solving a sparse matrix equation involving a sparse matrix, a first vector, and a second vector, the system comprising:
a plurality of field programmable gate arrays (FPGAs), each including a plurality of configurable logic elements and a plurality of configurable storage elements;
a matrix memory element accessible by the FPGAs and configured to store the matrix;
a vector memory element accessible by the FPGAs and configured to store the first vector;
a plurality of matrix memory element controllers formed from the configurable logic elements and the configurable memory elements and configured to access the matrix memory element and supply non-zero data of a row of the matrix;
a plurality of vector memory element controllers formed from the configurable logic elements and the configurable memory elements and configured to access the vector memory element and supply matching elements of the first vector that correspond to the non-zero data of the row of the matrix; and
a plurality of processing elements formed from the configurable logic elements and the configurable storage elements, each processing element configured to receive the non-zero data and the matching elements, to store one element of the second vector, and to solve an iteration for one element of the first vector.

14. The system of claim 13, wherein each processing element further includes a matrix-vector product summation unit configured to receive the non-zero data and the matching elements and to calculate a matrix-vector product sum.

15. The system of claim 14, wherein each processing element further includes a linear solver update unit configured to receive the matrix-vector product sum and the one element of the first vector from a previous iteration and to solve a current iteration for the one element of the first vector.

16. The system of claim 15, wherein the linear solver update unit further receives the one element of the second vector.

17. The system of claim 15, wherein the linear solver update unit further receives an inverse of a diagonal of the row of the matrix.

18. The system of claim 13, wherein each processing element further includes a communication transmission element configured to transmit the iteration for one element of the first vector to the plurality of vector memory controllers.

19. The system of claim 13, further including a plurality of inter FPGA links, each inter FPGA link included within one FPGA and configured to allow communication from one FPGA to another FPGA.
